(19) United States
(12) Patent Application Publication
(10) Pub. No.: US 2025/0332923 A1
(43) Pub. Date: Oct. 30, 2025

(54) DIAGNOSTICS FOR LOW VOLTAGE POWER SUPPLY AUTOMOTIVE COMPONENTS

(71) Applicant: Ford Global Technologies, LLC, Dearborn, MI (US)

(72) Inventors: Travis Down, Westland, MI (US); Mark Viergutz, Canton, MI (US)

(21) Appl. No.: 18/644,765

(22) Filed: Apr. 24, 2024

(51) Int. Cl. B60L 3/00; B60L 58/16; B60L 58/20

(52) U.S. Cl. CPC B60L 3/0046; B60L 58/16; B60L 58/20

(57) ABSTRACT

A vehicle has a first power network, a second power network including an auxiliary battery and an ultracapacitor, and a controller. The controller, during an off mode of the vehicle, disconnects the first power network and second power network from each other and cycles power between the auxiliary battery and ultracapacitor.

### TECHNICAL FIELD

This disclosure relates to automotive power systems.

### BACKGROUND

Many vehicles that include internal combustion engines have relied on lead-acid batteries, primarily serving to start the engine and power the electrical systems when the engine is not running. These batteries provide a high surge current necessary for cranking the engine. With the increasing electronic load in modern vehicles, from infotainment systems to numerous electronic aids, the demand on these batteries has significantly increased. Ultracapacitors and the like have been adopted in certain circumstances to help satisfy power demands.

### SUMMARY

A vehicle has a first power network including a first electrical bus, a starter motor, and a starter battery, a second power network including a second electrical bus, an auxiliary battery, and an ultracapacitor, and a controller. The controller, during an off mode of the vehicle, disconnects the first and second power networks from each other and cycles power between the auxiliary battery and ultracapacitor while the first and second power networks are disconnected from each other such that the auxiliary battery charges the ultracapacitor and then the ultracapacitor charges the auxiliary battery.

A method for a vehicle includes, during an off mode for the vehicle, disconnecting a first electrical bus from a second electrical bus and maintaining electrical connections between a pair of energy storage devices and the second electrical bus, cycling power between the pair while the first and second electrical busses are disconnected from each other, sensing parameters associated with the power, and generating data related to state of health or state of function of at least one of the pair based on the parameters.

A vehicle power system includes a controller that, during a vehicle off mode, disconnects a first power network from a second power network such that a pair of energy storage devices of the second power network are isolated from the first power network, while the first and second power networks are disconnected from each other, charges one of the pair with power from the other of the pair and then charges the other of the pair with power from the one of the pair, and generates data related to state of health or state of function of the pair based on sensed parameters associated with the powers.

### BRIEF DESCRIPTION OF THE DRAWINGS

FIG. 1 is a block diagram of portions of an automotive vehicle.

FIG. 2 is a flow chart of an algorithm for assessing parameters associated with energy storage devices of FIG. 1.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

ISO 26262 is an international standard relating to electrical and electronic systems within road vehicles. Its applicability can vary based on the specific vehicle's architecture and classification. Among other things, ISO 26262 outlines requirements and provides a framework for managing electrical and electronic system function. It, for example, suggests that some subsystems should have backup or partial modes of operation in certain circumstances to permit continued vehicle operation. It also suggests that certain power supply sources can be evaluated to confirm their state of function and state of health on a periodic basis and that these evaluations should be conducted so that power networks are fully available during normal vehicle operation.

The state of function and state of health of energy storage devices, such as batteries and ultracapacitors, can provide insight into the performance, efficiency, and remaining useful life of the energy storage devices. The state of function refers to the ability of the energy storage device to meet current performance requirements. It is a real-time indicator of the energy store's capacity to deliver the required power under specified conditions. Parameters that represent state of function may include (i) available energy: the remaining energy that can be delivered by the energy store under current conditions; (ii) available power: the maximum power that can be provided by the energy store in a given state of charge, temperature, and aging condition, and (iii) voltage stability: the ability of the energy store to maintain voltage within the required range under load.

The state of health is an estimate of the overall condition of an energy storage device and its ability to store and deliver energy compared to a newer unit. It is often expressed as a percentage of the original capacity. Parameters that represent state of health may include (i) internal impedance/resistance: higher internal impedance can indicate aging or degradation; it affects the energy store's ability to deliver power and accept a charge; (ii) charge capacity: the total amount of energy the energy store can store; this typically decreases with age and usage; (iii) cycle count: the number of complete charge-discharge cycles the energy store has undergone, which is related to its expected lifecycle; and (iv) temperature effects: operating and storage temperatures can affect state of health, with extreme temperatures affecting degradation.

Other indicators of state of function and state of health may include (i) self-discharge rate: how quickly an energy store loses its charge while not in use, which can increase with age and degradation; (ii) voltage response: changes in the voltage profile during charge and discharge cycles can indicate changes in the state of health; and (iii) charge acceptance: the ability of the energy store to accept charge, which can diminish with age. In the case of ultracapacitors, while some parameters are similar to those batteries, the focus may be more on current capability and the rate of capacitance loss, as ultracapacitors are typically used for their power handling capability rather than their energy capacity.

These parameters are typically monitored using a battery management system of some sort, which collects data from sensors (e.g., current sensors, voltage sensors, temperature sensors, etc.) associated with the energy storage devices. The battery management system uses this data to calculate state of function and state of health, providing feedback for the operational management of the energy stores.

When an energy storage device is charged, an external source applies a voltage higher than the energy storage device's current voltage, forcing current to flow into the energy storage device. In the case of a battery, this converts electrical energy into chemical energy stored in the battery's active materials. Charging processes often follow specific stages, such as constant current followed by constant voltage charging.

During discharge of a battery, the chemical energy is converted back into electrical energy to provide power to a load. The battery's voltage drops as it delivers current, and this discharge process continues until the battery reaches its cut-off voltage, which is set to prevent over-discharging.

Internal impedance/resistance, as alluded to above, is a measure of how much the energy storage device opposes the flow of electric current. It can be calculated by analyzing the voltage and current data collected during controlled charge or discharge cycles using methods like DC resistance tests.

DC resistance tests can be performed in several ways. In the current interrupt method, a known current is passed through the energy storage device, and just after the current is interrupted, the change in voltage is recorded. The internal resistance can be calculated using Ohm's Law, R=ΔV/ΔI, where R is the resistance, ΔV is the voltage change, and ΔI is the change in current. The hybrid pulse power characterization method applies a current pulse to the energy storage device and measures the voltage response. The resistance is again calculated using Ohm's Law based on the initial voltage drop and the applied current. Simplified models based on voltage and current variations with load changes, or more complex models that consider factors such as aging effects may also be used.

Charge capacity, often measured in ampere-hours (Ah), represents the amount of charge a battery can hold and deliver at its nominal voltage. A discharge test can be used to determine this parameter, which may involve fully charging the energy storage device to its maximum voltage limit and discharging the device to its cut-off voltage at a constant current that represents a typical or standard discharge rate. The charge capacity can be determined by integrating the constant discharge current over the time it takes to reach the cut-off voltage. Adjustments may be made for temperature, aging, etc.

Voltage stability in an energy storage device refers to its ability to maintain a consistent voltage level under various load conditions and over time. Determining voltage stability involves monitoring the voltage response during charge and discharge cycles, as well as during static (no-load) conditions. Load tests may apply a constant current load and monitor the voltage drop. A stable voltage with a gradual decline is typically expected. Sharp voltage drops may indicate instability or poor health of the energy storage device. Load tests may also apply intermittent pulses of high current load and observe the voltage response. A stable energy storage device will show a quick voltage recovery after each pulse. Static tests may measure the voltage of the energy storage device when it is at rest (not supplying or being charged with power). A stable open circuit voltage over time suggests good voltage stability. Static tests may also, after charging or discharging, let the device rest and measure how the voltage settles. A stable device will show little change in open circuit voltage (OCV) during rest periods.

Per ISO 26262 and other standards, automotive energy storage devices supporting certain functional requirements may be required to assess capability to support a predetermined power demand. For internal combustion vehicles, on-board energy storage is limited to batteries, typically lead acid, and capacitors. Where electric vehicles can utilize high voltage battery packs for evaluating energy sources and load devices, internal combustion vehicles may have more limited electric energy stores.

Here, a low volt battery and ultracapacitor module (or other types of energy sources) in certain arrangements are used in tandem to assess the state of function and state of health of both energy sources—trading energy between the two to collect the data necessary for such determinations. Both energy sources may be used to assess capacity, internal resistance, and predicted voltage response by charging and discharging at measured voltages and currents for a limited amount of time. The ultracapacitor module may incorporate a buck/boost converter to facilitate raising/lowering the ultracapacitor module voltage as seen by the secondary power network. At regular intervals under predefined conditions (e.g., at key off, at night), a vehicle control module may isolate the low voltage battery and ultracapacitor module by opening select switches in a power distribution center. The ultracapacitor module may run a charge/discharge profile during vehicle off to evaluate both the secondary power network battery and ultracapacitor module capacitors. The low voltage battery may also run charge/discharge profiles during vehicle off for such evaluations. Power networks may need to be separated by switches therebetween. A vehicle control module may initiate the procedure and control the appropriate switches.

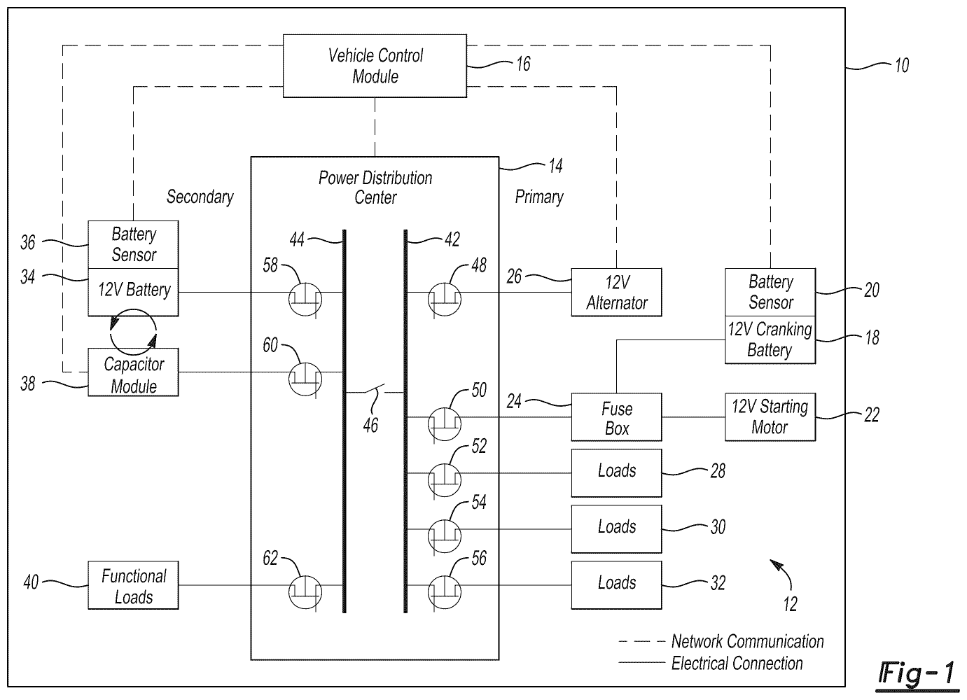

Referring to FIG. 1, a vehicle 10 includes a power system 12. The power system 12 includes a power distribution center 14, a vehicle control module 16 (e.g., a controller including a processor and memory), a 12-volt cranking battery 18, battery sensors 20, a 12-volt starter motor 22, a fuse box 24, a 12-volt alternator 26, loads 28, 30, 32 (e.g., entertainment system, interior lighting, air conditioning, etc.), a 12-volt battery 34, battery sensors 36, an ultracapacitor module 38, and functional loads 40 (e.g., electronic steering, electronic braking, headlights, etc.).

The power distribution center 14 can be electrically connected with each of the 12-volt cranking battery 18, 12-volt starter motor 22, fuse box 24, 12-volt alternator 26, and loads 28, 30, 32, which define a primary side for the power distribution center 14. The power distribution center 14 also can be electrically connected with each of the 12-volt battery 34, ultracapacitor module 38, and functional loads 40, which define a secondary side for the power distribution center.

The vehicle control module 16 is in communication with the power distribution center 14, battery sensors, 20, 36, 12-volt alternator 26, and ultracapacitor module 38 (and other controllers/modules/sensors of the vehicle 10).

The battery sensors 20 (e.g., current sensors, voltage, sensors, temperature sensors, etc.) are arranged to detect various parameters associated with the 12-volt cranking battery 18. The fuse box 24 is connected between the power distribution center 14 and 12-volt cranking battery 18 and 12-volt starter motor 22.

The battery sensors 36 (e.g., current sensors, voltage sensors, temperature sensors, etc.) are arranged to detect various parameters associated with the 12-volt battery 34. The ultracapacitor module 38 similarly includes sensors arranged to detect various parameters associated therewith. The ultracapacitor module 38 also includes ultracapacitors and a buck/boost converter as suggested above.

The power distribution center 14 includes busses 42, 44 and switches 46, 48, 50, 52, 54, 56, 58, 60 (e.g., contactors, field effect transistors, etc.). The switch 46 is electrically connected between the busses 42, 44. The switch 48 is electrically connected between the 12-volt alternator 26 and bus 42. The switch 50 is electrically connected between the fuse box 24 and bus 42. The switches 52, 54, 56 are electrically connected between the loads 28, 30, 32, respectively, and bus 42. The switch 58 is electrically connected between the 12-volt battery 34 and bus 44. The switch 60 is electrically connected between the ultracapacitor module 38 and bus 44. The switch 62 is electrically connected between the functional loads 40 and bus 44.

Opening the switch 46 can isolate the busses 42, 44 from each other, and thus isolate the primary and secondary sides of the power distribution center 14. Opening the switches 48, 50 52, 54, 56 can disconnect the components associated therewith from the bus 42. Opening the switches 58, 60, 62 can disconnect the components associated therewith from the bus 44.

The vehicle control module 16 using standard techniques may detect the vehicle 10 has been deactivated (e.g., turned off). During such times, it may open the switch 46 to disconnect the busses 42, 44 from each other, and ensure the switches 58, 60 remain closed to maintain electrical connections between the 12-volt battery 34 and ultracapacitor module 38 via the bus 44. The vehicle control module 16 may then initiate the charge cycling between the 12-volt battery 34 and ultracapacitor module 38 mentioned above. In one scenario, power from the ultracapacitor module 38 may be used to charge the 12-volt battery 34 with any suitable charge profile. Power from the 12-volt battery 34 may then be used to charge the ultracapacitor module 38 with any suitable charge profile. During this cycling, the battery sensors 36 and sensors of the ultracapacitor module 38 may detect currents, voltages, temperatures, etc. associated with the charging and report the same to the vehicle control module 16. The vehicle control module 16, using these measurements, may then generate data indicative of the state of health and/or state of function of the 12-volt battery 34 and ultracapacitor module 38 via the techniques described above (or via other suitable techniques). If all is in order, the vehicle control module 16 may log the data in files. Otherwise, it may report or display the state of health and/or state of function parameters to interested users (e.g., an owner of the vehicle 10, etc.). Prior to or during activation of the vehicle 10 for driving, the vehicle control module 16 may close the switch 46 to reconnect the busses 42, 44.

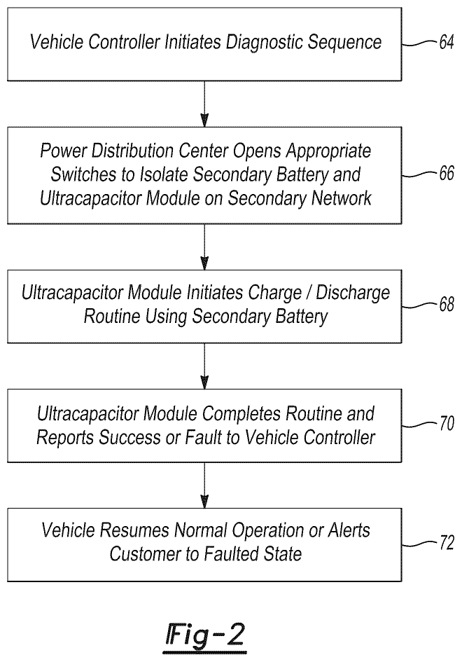

Referring to FIG. 2, at operation 64 the vehicle control module 16 initiates a diagnostic test sequence. This test sequence may be initiated periodically or at scheduled intervals when the vehicle 10 is not in use. At operation 66, the power distribution center 14 opens the switch 46, while maintaining the switches 58, 60 closed, to isolate the 12-volt battery 34 and ultracapacitor module 38 from the bus 42. At operation 68, the ultracapacitor module 38 initiates a charge/discharge routine using the 12-volt battery 34. Power from the 12-volt battery 34 flows to the ultracapacitor module 38 via the bus 44 for some predetermined period of time. The battery sensors 36 and sensors of the ultracapacitor module 38 detect characteristics associated with the power flow. At operation 70, the ultracapacitor module 38 completes the routine and reports success or fault conditions to the vehicle control module 16. Power from the ultracapacitor 38 flows to the 12-volt battery 34 again via the bus 44. The battery sensors 36 and sensors of the ultracapacitor module 38 again detect characteristics associated with the power flow. At operation 72, the vehicle 10 resumes normal operation or alerts the customer to a faulted state based on the state of health and/or state of function determinations from the detected characteristics.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a first power network including a first electrical bus, a starter motor, and a starter battery,
a second power network including a second electrical bus, an auxiliary battery, and an ultracapacitor; and
a controller programmed to, during an off mode of the vehicle, disconnect the first and second power networks from each other and cycle power between the auxiliary battery and ultracapacitor while the first and second power networks are disconnected from each other such that the auxiliary battery charges the ultracapacitor and the ultracapacitor charges the auxiliary battery.

2. The vehicle of claim 1 further comprising sensors configured to measure parameters associated with the power cycled between the auxiliary battery and ultracapacitor.

3. The vehicle of claim 2, wherein the controller is further programmed to generate data related to state of health or state of function of at least one of the auxiliary battery and ultracapacitor based on the parameters.

4. The vehicle of claim 3, wherein the data is for display.

5. The vehicle of claim 1, wherein the controller is further programmed to connect the first and second power networks for a drive mode of the vehicle.

6. The vehicle of claim 1, wherein the disconnecting includes opening a switch.

7. The vehicle of claim 1, wherein the auxiliary battery and ultracapacitor are configured to be electrically connected with the second electrical bus while the first and second power networks are disconnected from each other.

8. A method for a vehicle comprising:
during an off mode for the vehicle,
disconnecting a first electrical bus from a second electrical bus and maintaining electrical connections between a pair of energy storage devices and the second electrical bus,
cycling power between the pair while the first and second electrical busses are disconnected from each other,
sensing parameters associated with the power, and
generating data related to state of health or state of function of at least one of the pair based on the parameters.

9. The method of claim 8, wherein the disconnecting includes opening a switch.

10. The method of claim 8, wherein the cycling includes discharging power from one of the pair to the other of the pair and then discharging power from the other of the pair to the one of the pair.

11. The method of claim 8 further comprising displaying the data.

12. The method of claim 8 further comprising connecting the first and second electrical busses for a drive mode of the vehicle.

13. The method of claim 12 further comprising connecting a starter motor or a starter battery to the first electrical bus for the drive mode.

14. The method of claim 8, wherein the one of the pair is an auxiliary battery and the other of the pair is an ultracapacitor.

15. A vehicle power system comprising:
a controller programmed to, during a vehicle off mode,
disconnect a first power network from a second power network such that a pair of energy storage devices of the second power network are isolated from the first power network,
while the first and second power networks are disconnected from each other, charge one of the pair with power from the other of the pair and then charge the other of the pair with power from the one of the pair, and
generate data related to state of health or state of function of the pair based on sensed parameters associated with the powers.

16. The vehicle power system of claim 15, wherein the controller is further programmed to connect the first and second power networks for a vehicle drive mode.

17. The vehicle power system of claim 15, wherein the controller is further programmed to generate an alert for a vehicle user based on the data.

18. The vehicle power system of claim 15, wherein the controller is further programmed to maintain a connection between a bus of the second power network and the pair while the first and second power networks are disconnected from each other.

19. The vehicle power system of claim 15, wherein the controller is further programmed to open a switch of a power distribution center to disconnect the first and second power networks.

20. The vehicle power system of claim 15, wherein one of the pair is an ultracapacitor and the other of the pair is an auxiliary battery.
